(19) United States
(12) Patent Application Publication
(10) Pub. No.: US 2003/0090565 A1
(43) Pub. Date: May 15, 2003

(54) Autostereoscopic imaging system

(76) Inventor: William Lee Torgeson, Pittsburgh, PA (US)

Correspondence Address: KENYON & KENYON, 1500 K STREET, N.W., SUITE 700, WASHINGTON, DC, 20005, US

(21) Appl. No.: 10/269,994

(22) Filed: Oct. 15, 2002

Related U.S. Application Data
(60) Provisional application No. 60/329,302, filed on Oct. 16, 2001.

(51) Int. Cl. H04N 13/04

(52) U.S. Cl. 348/52; 348/37

(57) ABSTRACT

An imaging system for producing autostereoscopic television images allowing viewers in a large viewing area to view 3-D images by sending separate left and right-hand images to the left and right eyes respectively, when a viewer looks at a small region of a 3-D display. In one embodiment, a projection system projects left and right-hand images to a small moveable mirror, which then reflects both images separately through a lenslet array, and then to a cylindrical lens panel. A means for imparting motion to the moveable mirror is also disclosed.

### CROSS-REFERENCE

This application claims the benefit of U.S. Provisional Application No. 60/329,302, filed Oct. 16, 2001.

### BACKGROUND OF THE INVENTION

This invention is directed to means for producing three-dimensional images in such a way that viewers sitting or standing anywhere within a large viewing area will perceive three-dimensional images without using glasses.

Despite important advances in television art and technology, TV imaging is still limited to two-dimensional representations of three-dimensional objects. Anaglyphic glasses have been used for many years for 3-D viewing of both still pictures and television displays but have not been accepted by the general public.

The inherent advantages of three-dimensional imaging have spurred many inventors to develop 3-D imaging concepts. Hines, U.S. Pat. No. 5,614,941 discloses an autostereoscopic imaging system which employs a multiplicity of views of a subject from different directions. In general, systems of this type afford best results when a large number of views are used.

Eichenlaub describes several autostereoscopic display systems which employ direct-view liquid crystal panels. His U.S. Pat. No. 5,349,379 uses head position sensors to permit viewing of 3-D images by one or more observers. U.S. Pat. No. 4,829,365 issued to Eichenlaub combines a flat liquid crystal display with equally-spaced vertical light sources to enable left/right eye separation.

Recent autostereoscopic imaging systems which employ holographic optical elements (HOEs) show promise for autostereoscopic imaging. Examples are U.S. Pat. No. 5,521,724 issued to Shires and U.S. Pat. No. 6,157,474 disclosed by Orr.

U.S. Pat. No. 6,157,402 issued to Torgeson provides full separation of left/right views for multiple viewers, but restricts viewing positions, a limitation which the present application seeks to overcome.

### SUMMARY OF THE INVENTION

Embodiments of the present invention provides stereoscopic imaging by sending separate left- and right-hand images to the left and right eyes, respectively, when a viewer looks at a small region of a 3-D display. This is achieved, first, by separately displaying left- and right-hand views of three-dimensional objects on the image source (e.g., an LCD panel) and, second, by projecting picture elements (pixels) to the eyes of a viewer so that the left eye sees only the left-hand view and the right eye sees only the right-hand view at any small region on which the eyes are focused.

A projection system is used for image display, in conjunction with a cylindrical lens panel. The lenses of the cylindrical lens panel are vertically oriented and are uniform in width and lens profile. Also, there is a one-to-one correspondence between lenses making up the cylindrical lens panel and pixels (or pixel elements) arrayed horizontally across the width of the image source. The projection system transforms light from pixels of the image source to “dots” displayed on an imaging screen. The imaging screen is parallel with the cylindrical lens panel and located very close to the focal plane of the lens panel. In one embodiment, successive scan lines alternate between left- and right-hand views of a 3-D object with dots corresponding to left- and right-hand pixels scattering light in the forward direction to the same lens. Dots for right-hand pixels are shifted relative to the left-hand dots, either optically or by horizontal shifting at the image source.

Due to the optical properties of cylindrical lenses, light scattered from a given dot can be projected into the viewing area as a narrow beam. Also, in one embodiment, the deflection angle of the projected light beams (with respect to the lens axis) is proportional (with very high accuracy) to the displacement of the dot from the lens centerline. Due to the aforementioned right shift, light for left- and right-hand views (with proper design parameters) are seen separately by the left and right eyes, respectively.

The autostereoscopic display system in employs a small front-surface mirror to reflect light from the projection system to the imaging screen. In one embodiment, the mirror may be fixed at 45° to the projection axis, so that dots are directed to the center of each cylindrical lens element. To permit stereoscopic viewing over a large viewing region, embodiments of the present invention incorporate means for moving the mirror, generally by combining rotation and lateral translation. The effect of mirror movements in each case is to enable a viewer to see a series of light flashes (e.g., at several times the frame frequency, with two flashes per frame) when looking at a small region of the display, with full separation of left and right views in the region. Panning over the display, the same result is obtained over the entire display area. Clearly, if the viewer moves to another location in the viewing region, a stereoscopic picture will again be seen.

This imaging system utilizes the natural binocular function of human vision whereby 3-D images are perceived by focusing the eyes point-by-point over an object to determine its three-dimensional shape.

### BRIEF DESCRIPTION OF DRAWINGS

FIG. 1 is a generalized top view illustrating binocular viewing of a three-dimensional object.

FIG. 2 is a schematic view from above showing the elements of the autostereoscopic system of the present invention.

FIG. 3 shows a view from above of the projection optical arrangement used in the present invention.

FIG. 4 is a horizontal sectional view showing a portion of the imaging screen and cylindrical lens panel.

FIG. 5 is a view of the imaging screen as seen from the viewing region (cylindrical lens panel removed).

FIG. 6 illustrates the way light scattered by the imaging screen passes through a typical lens of the cylindrical lens array, forming left- and right-hand light beams which are projected into the viewing region.

FIG. 7 is a large scale top view showing how left- and right-hand projected image beams from a small region of the cylindrical lens panel are seen by a viewer.

FIG. 8 shows details of a mechanism for mirror movement.

### DETAILED DESCRIPTION

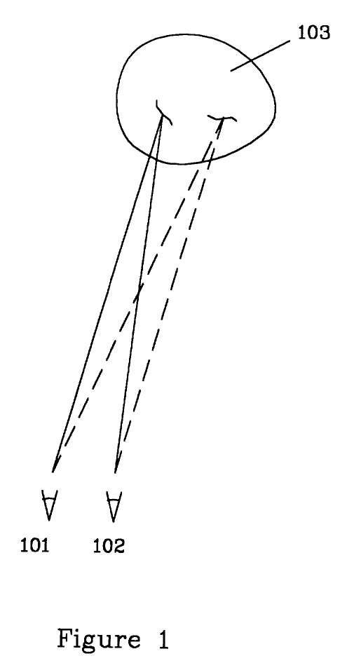

The atuostereoscopic imaging system described herein is designed to produce three-dimensional images by presenting separate left- and right-hand images to the viewer's left and right eyes, respectively. FIG. 1 illustrates how a persons eyes are focused on an object 103 to determine its shape and how far away it is. Thus, at any instant a viewers left 101 and right 102 eyes are focused at a small point (or region) on an object in the field of view. The brain autonomously processes the views of each eye to determine the distance to that point. The three-dimensional shape of the object is determined by panning over the object point-by-point. It should be noted that both eyes see the entire field of view, but that only the region of focus is seen stereoscopically.

Left- and right-hand views can be obtained by using a stereoscopic camera or by other means. The present invention displays these views as three-dimensional images just as if they were seen directly by the eyes from the same vantage-point.

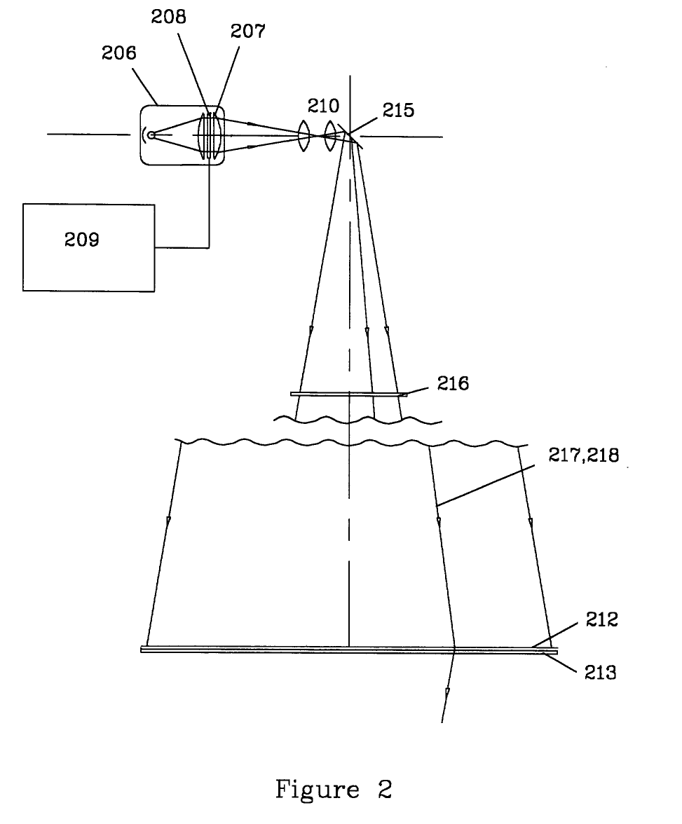

A schematic view of a version of the present invention, viewed from above, is shown schematically in FIG. 2. The atuostereoscopic imaging system in FIG. 2 includes an image source 206 (e.g., a Seiko-Epson projection model), an optical projection system 210, a small mirror 215 which reflects the projected light rays through lenslet array 216, to an imaging screen 212 which scatters light in a generally forward direction toward a cylindrical lens panel 213, which in turn directs light to the left and right eyes of a viewer.

Light from projection module 206 is focused by lens 207, toward projection lenses 210. Front-surface mirror 215 reflects light from lenses 210 to lenslet array 216. Lenslet array 216 accepts light from each projected pixel (e.g., light beams 217, 218), focusing this light as a multiplicity of “dots” on imaging screen 212. Light from each dot is scattered in a generally forward direction by imaging screen 212, passing in turn through cylindrical lens panel 213, which projects light into the viewing region. Light from a particular left- and right-hand pixel pair, depicted by light beams 217, 218, pass through the same lens of cylindrical lens panel 213, directing light from these pixels to the left and right eyes, respectively, of viewer 214 (Due to their close proximity, light beams 217 and 218 are indistinguishable in FIG. 2).

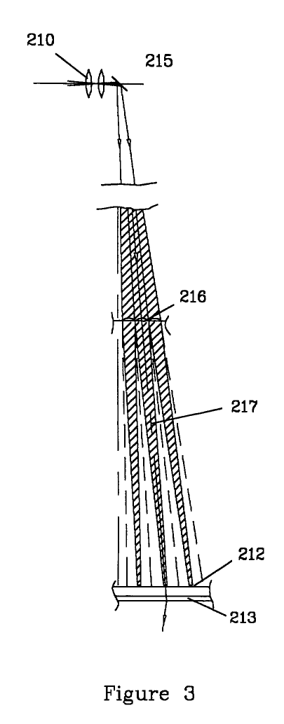

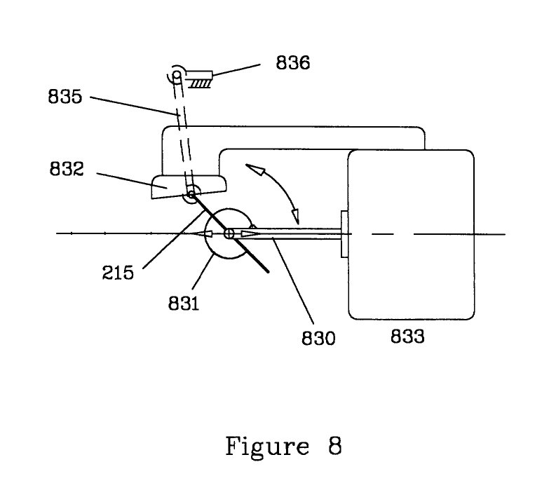

A mechanical drive is provided to shift mirror 215 by a small amplitude δx about its center position (with a small accompanying rotation) at a vibrational frequency generally higher than 30 Hz, the frame frequency of the image source. It should be noted that a repetition frequency of about 16 Hz or greater is sufficient to cause an image to appear to be continuous. FIG. 3 (not to scale) illustrates the configuration of mirror 215, lenslet array 216 and imaging screen 212, as viewed from above. Note that the light from pixels of the image source are reflected by mirror 215 and then pass through the center of each lens of lenslet array 216. This requires that an angular shift δφ accompany the lateral shift δx in order to direct a light ray (e.g., ray 217) through lens elements of lenslet array 216, producing an illuminated dot on imaging screen 212. FIG. 3 also shows (dashed lines) the light path to imaging screen 212 without the lenslet panel, corresponding to the usual configuration of a two-dimensional projector. Additional details of mirror 215 are given in FIG. 8.

The image source can be a high-luminance CRT tube, a Seiko-Epson module or a DLP-based source. The latter two image sources are desirable because they project a narrow image beam and are thus compatible with small diameter glass lenses 207, producing a small light-ray bundle at mirror 215. In contrast, a CRT image source generally requires Fresnel lenses 207, which tend to produce a broader light-ray bundle. The image source module shown in FIG. 2 shows a high-intensity light source (e.g., a halogen lamp), with light directed through small vertical stripe LCD panel 208 by means of lenses 207 which focus light toward projection lenses 210.

It should be added that the projection system should be linear, with essentially uniform magnification over the projected image at imaging screen 212, a condition which is most easily achieved with solid glass lenses. In general, this condition is best achieved by employing lenses with relatively high f/#'s and by using a long projection light path.

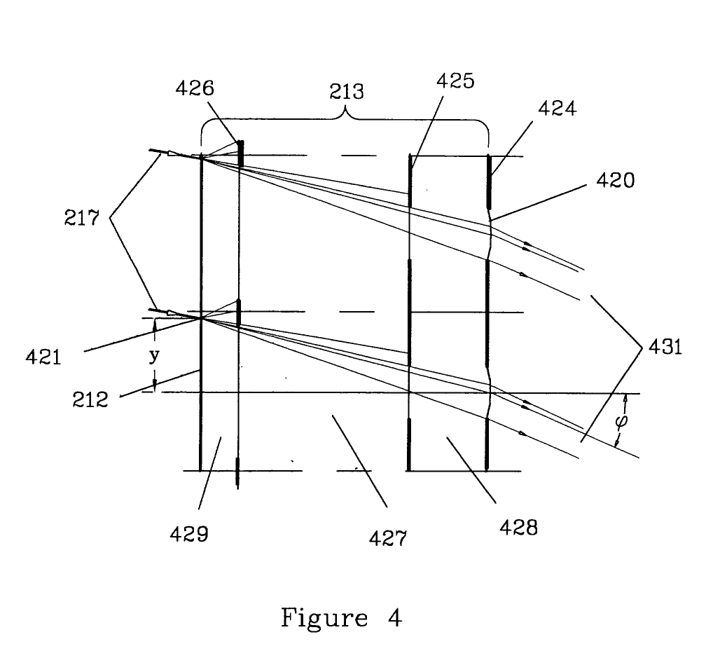

FIG. 4 is a horizontal top sectional view, through a small portion of imaging screen 212 and cylindrical lens panel 213. In one embodiment, as shown in the figure, the cylindrical lens panel consists of glass core 427, transparent lens element 428 and transparent spacer element 429. Elements 428 and 429 are bonded to core 427 and are formed by casting or molding techniques. Other configurations are also compatible with the invention. In the illustration, light beams 217, impinging on imaging screen 212, producing illuminated dots 421. Light from dots 421 is scattered toward lens 420 on cylindrical lens panel 213. Opaque stops 424, 425 and 426 are provided to define light rays passing through lens 420. By locating imaging screen 212 close to the focal plane of lens 420, light exits 420 as a narrow beam 431 to a viewer's eye. With careful design, the mean deflection angle Φ of light beam 431 is almost exactly proportional to the distance y from the lens centerline to the center of dot 421.

Imaging screen 212 serves to scatter light form lenslet array 216 in a generally forward direction toward lenses 420. The desired scattering characteristics can be produced by roughening imaging screen 212 in such a way that light is scattered in a relatively broad horizontal pattern with a more restricted vertical pattern, using methods well known in geometric optics.

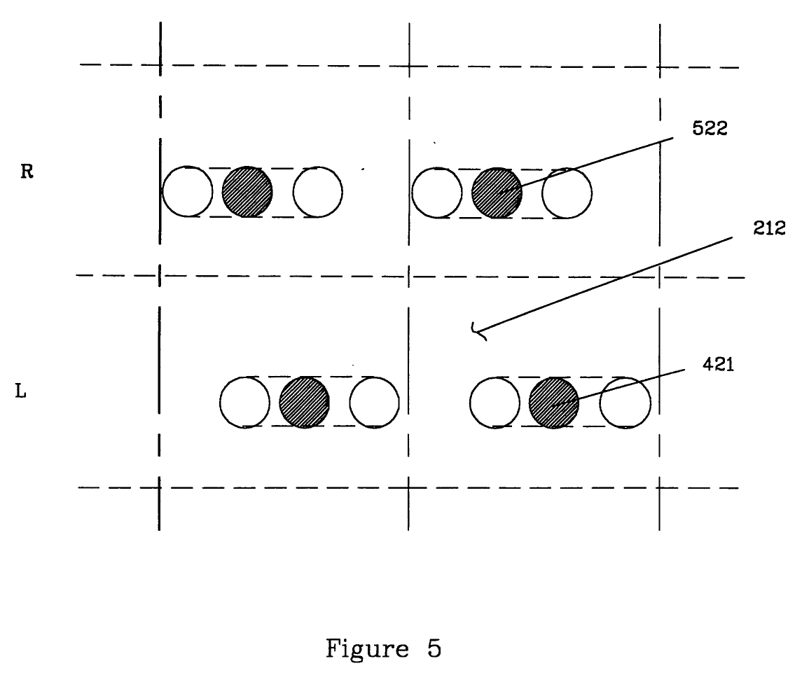

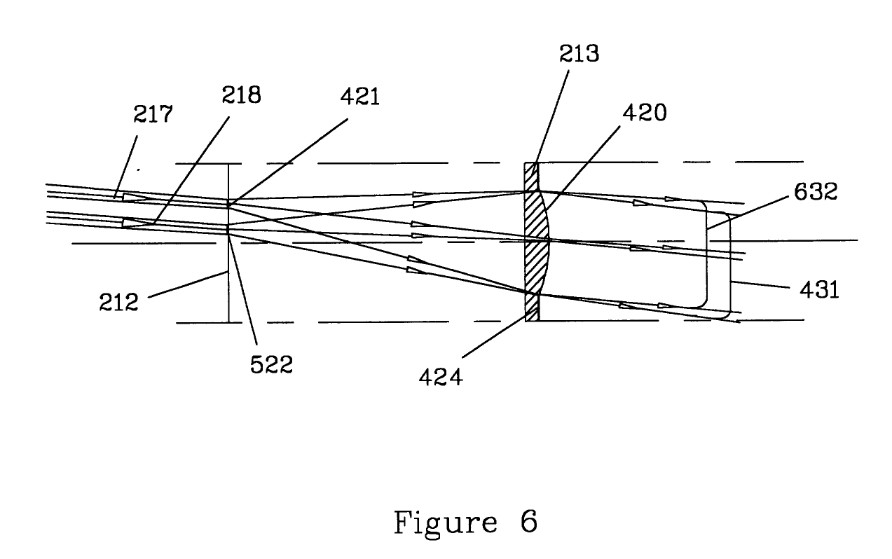

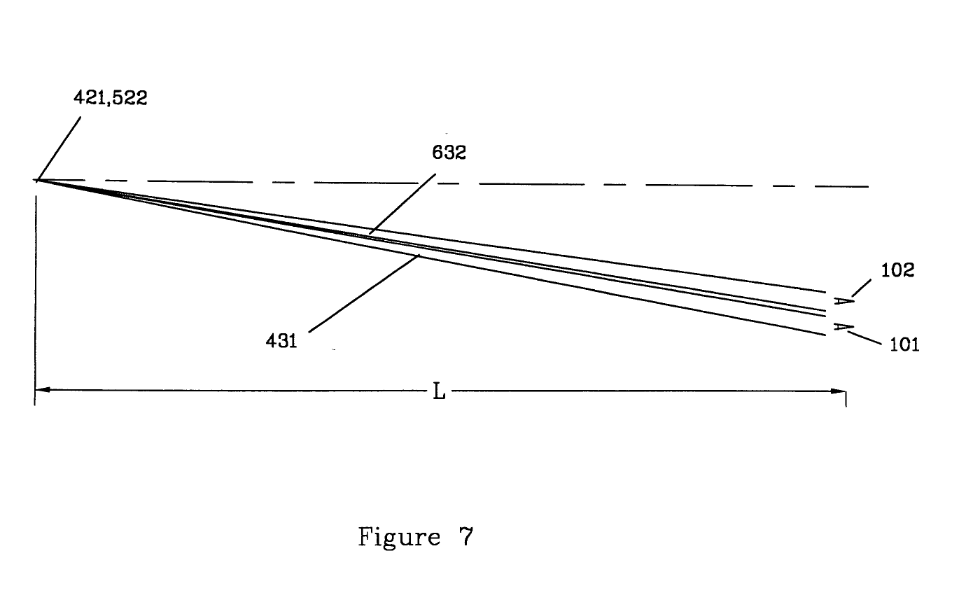

In one embodiment of the imaging system, successive scan lines of the imaging source alternate between a left- and right-hand view of a 3-D image. Also, right-hand scan lines are shifted laterally, either at the image source or by shifting lenses corresponding to right-hand pixels on lenslet array 216. The shift is selected to separate left and right pixels projected as dots on imaging screen 212. The effect of this shift is illustrated in FIG. 5, which is a view perpendicular to imaging screen 212, as seen from the viewing region. As indicated, right-hand dot 422 is projected so as to place it just to the left of left-hand dot 421, with both dots scattering light to the same cylindrical lens, as shown in FIG. 6. Left- and right-hand light beams 431 and 632 (corresponding to dots 421 and 522 respectively), are projected to a viewer's eyes as illustrated generally in FIG. 6 and also in FIG. 7, which is a large-scale top view of the viewing region, including the cylindrical lens panel. FIG. 6 is a horizontal section view of a single “cell” of the imaging/cylindrical lens panel, simplified in the interests of clarity. It is important to observe that left/right separation of pixels displayed on imaging screen 212 extends over an area roughly comparable to the eye spacing of a viewer. It is apparent that a full screen view is also presented to the eyes of a viewer, although only the region of focus is capable of separating left and right views.

By imparting lateral and rotational motion to mirror 215, light from each pixel of the image source will be projected into the viewing region with full separation of the left and right views at any small region of the display when a viewer focuses his/her eyes on the region. An arrangement for producing the required motion of mirror 215 is shown in FIG. 8, based on the geometry depicted in FIG. 3. Yoke 830 vibrates laterally as indicated by the arrows. The mirror 215 is pivoted about a vertical axis passing through the front of the mirror. Spring 831 maintains low-friction contact between one edge of the mirror 215 and an inclined guide plate 832. Thus, as the mirror 215 moves back and forth laterally, it also moves cyclically through a small angle δφ with respect to its mean angle of 45°. The inclination of guide plate 832 can be determined from the geometry shown in FIG. 3. An electromagnetic (e.g., moving coil) motor 833 is shown in FIG. 8 to produce movement of mirror 215. An alternative means for guiding the mirror rotation is to replace guide plate 832 with connecting link 836, with one end rotating about a fixed pinion and the other end attached by means of a low-friction bearing to the mirror edge, as shown schematically by dashed lines in FIG. 8. A rotary mirror drive mechanism employing an offset crank can be used advantageously as an alternative to the moving coil arrangement shown in FIG. 8.

Alternatively, progressive scanning is possible with successive frames representing left- and right-hand views of a three-dimensional scene. In this case an overall average shift of mirror 215 can be used from frame to frame to achieve the necessary parallax shift, the needed dynamic lateral shift δx and rotation δφ being superimposed on the mean values.

The autostereoscopic system and its component elements must be fabricated very precisely. High-precision molds are needed for lenslet array 216 and the cylindrical lens assembly comprising imaging screen 212 and cylindrical lens panel 213.

The cylindrical lens mold can be fabricated from a composite mold block consisting of an aluminum alloy base about 0.375″ thick, with a 0.125″ thick pure tin sheet cemented to one face of the base. The lateral dimensions of the mold block are sufficient to accommodate the cylindrical lens panel. A very smooth cylindrical lens surface can be produced by first using a precision ball end milling tool (e.g., a diamond tool from Technodiamont, USA) to mill grooves of circular profile in the mold block, using a cnc machine. A final very smooth surface finish can be obtained by drawing a special tool incorporating a ball bearing mounted axially on a steel shank along each groove, employing a suitable low-viscosity lubricant.

A master mold of this type can be used to cast cylindrical lens panels, using a transparent epoxy casting resin such as Hysol System 2039/3561 from Dexter Chemical. The master cylindrical lens panel can in turn be used to produce a more durable production mold by plating techniques of the type used to produce stampers for pressing LP records.

A master mold for lenslet array 216 can also be produced by using a very precisely shaped diamond ball end mill tool or by other means.

What is claimed is:

1. An autostereoscopic imaging system enabling viewers in a large viewing area to view 3-D images by focusing the eyes point-to-point over a viewing screen, comprising:
an optical projection system to project pixels of left and right hand views of an image;
a moveable mirror positioned to receive images from the optical projection system;
a lenslet array to focus light from the moveable mirror onto an imaging surface; and
a cylindrical lens panel to recieve images from the lenslet array, and to transmit the images to the viewing screen.

2. The imaging system of claim 1 wherein the cylindrical lens panels are vertically oriented and vertically adjacent pixel elements pass through the same cylindrical lens element.

3. The imaging system of claim 1 wherein the cylindrical lens comprises a transparent lens element and a transparent spacer element bonded to a glass core.

4. The imaging system of claim 1 and further including a drive to impart lateral and rotational motion to the moveable mirror to provide full separation of left and right-hand views.

5. The imaging system of claim 4 wherein said drive comprises:
a yoke, with a distal and proximal end;
a mirror attached to the proximal end of the yoke, such as to be free to pivot about the point of attachment;
a stationary inclined guide plate;
a spring attached to the mirror and proximal end of yoke, providing pressure on the mirror so that one edge of the mirror maintains a low-friction contact with the stationary inclined guide plate; and
an electromagnetic motor attached to the proximal end of the yoke

6. The imaging system of claim 4 wherein said drive comprises:
a stationary yoke, with a distal and a proximal end;
a low friction bearing;
a mirror attached to the proximal end of the yoke, such as to be free to pivot about the point of attachment, wherein at least one edge of the mirror is connected to said low friction bearing;
a fixed pinion; and
a linkage with a proximal and a distal end, the proximal end connected to said fixed pinion for rotation thereabout, and the distal end of the linkage attached to the low friction bearing.

7. The imaging system of claim 1 where the image source is a high-luminance CRT tube.

8. The imaging system of claim 1 where the image source is an LCD module.

9. The imaging system of claim 1 where the image source is a DLP-based source.

10. A method of producing autostereoscopic images to viewers in a large viewing area comprising:
projecting left and right-hand images from an image source through a projection lenses to a moveable mirror;
imparting motion on the mirror to separately reflect left and right-hand images;
laterally shifting right-hand images; and
reflecting successive left and right-hand views from the moveable mirror through a lenslet array to an imaging screen and then to a cylindrical lens panel.

11. The method of claim 10, further comprising an optical projection system laterally shifting right-hand scan lines corresponding to right-hand pixels.

12. The method of claim 10, further comprising a lenslet array laterally shifting right-hand scan lines corresponding to right-hand pixels.
